(19) United States
(12) Patent Application Publication
(10) Pub. No.: US 2017/0300590 A1
(43) Pub. Date: Oct. 19, 2017

(54) METHOD AND SYSTEM FOR TRANSMISSION OF A MESSAGE TO AUTHORIZED RECIPIENTS WITH SELECTED CONTENT

(71) Applicant: StarClub, Inc., Santa Monica, CA (US)

(72) Inventor: Bernhard Fritsch, Nassau (BS)

(73) Assignee: StarClub, Inc., Santa Monica, CA (US)

(21) Appl. No.: 15/612,361

(22) Filed: Jun. 2, 2017

Related U.S. Application Data
(63) Continuation-in-part of application No. 14/980,011, filed on Dec. 28, 2015.
Application No. 14/980,011 is a continuation-in-part of application No. 13/327,513, filed on Dec. 15, 2011.
(60) Provisional application No. 62/344,688, filed on Jun. 2, 2016.
(60) Provisional application No. 62/220,116, filed on Sep. 17, 2015.
(60) Provisional application No. 62/097,189, filed on Dec. 29, 2014.
(60) Provisional application No. 61/423,495, filed on Dec. 15, 2010.

(51) Int. Cl. G06F 17/30; G06F 21/10; H04L 29/06; G06Q 30/02; G06Q 10/06; H04L 12/58

(52) U.S. Cl. CPC G06F 17/30876; H04L 51/32; G06F 21/10; H04L 65/4084; H04L 65/4076; G06F 17/3089; G06Q 30/0273; G06Q 10/06; H04L 65/1059; H04L 2463/101

(57) ABSTRACT

This invention discloses a novel system and method for selecting a featured operator based on demographic data associated with the featured operator's authorized recipients across one or more communications systems, integrating selected authorized content with a message, and then managing the transmission of the integrated message to the authorized recipients while tracking usage of the selected content.

### PRIORITY

This application claims priority as a non-provisional application to U.S. Patent App. No. 62/344,688, filed on Jun. 2, 2016. This application is a continuation in part of U.S. patent application Ser. No. 14/980,011 filed on Dec. 28, 2015, which claims priority to U.S. Provisional Pat. App. No. 62/220,116, filed on Sep. 17, 2015, and also claims priority to U.S. Provisional Pat. App. No. 62/097,189, filed on Dec. 29, 2014, all of which are incorporated by reference in their entireties for all that they teach. This application is a continuation-in-part of U.S. patent application Ser. No. 13/327,513, filed on Dec. 15, 2011, which claims priority to U.S. Provisional Pat. App. No. 61/423,495, filed on Dec. 15, 2010, both of which are hereby incorporated by reference in their entireties for all that they teach.

This application incorporates by reference U.S. patent application Ser. No. 13/455,397 filed on Apr. 25, 2012, now U.S. Pat. No. 8,928,810, issued on Jan. 6, 2015, for all that it teaches.

### FIELD OF INVENTION

The present invention generally relates to the field of distributing audio-visual content selectively using computer systems linked by a data network. The invention operates in a manner that permits one person operating with a higher level of control over the interaction to control the flow of information by and among all of the participants using the system and communicating in a session. In addition, the controlling person, referred to herein as the featured operator, can utilize the system to control how the featured operator's relationship data is utilized by other systems that may want to distribute ancillary audio-visual content through the system. The system integrates such ancillary content into the featured operator's message data prior to transmission.

### BACKGROUND

There are several kinds of computer systems that permit users to communicate with other selected users. The selection processes may vary, but of particular interest are selections that are interactive in nature. In these systems, one person using a communications system may have control over a list of system users that establishes the authority for that one person to communicate with such other persons. In one embodiment, that list is a proprietary set of data that is proprietary to that one user. Some users have short lists, but other users may have very long lists of authorized recipients of communications from that user that owns that list. In these cases, that person, which typically is the featured operator, can transmit messages to those other users that appear on the featured operator's list and those messages will typically be received by all or virtually all of the users on that list.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

FIG. 1: An example system architecture embodying the invention. N indicates that there are may be N different communication systems. M indicates that there may be M recipients and O represents that there may be O external content systems transmitting O corresponding value items to the syndicating sub-system.

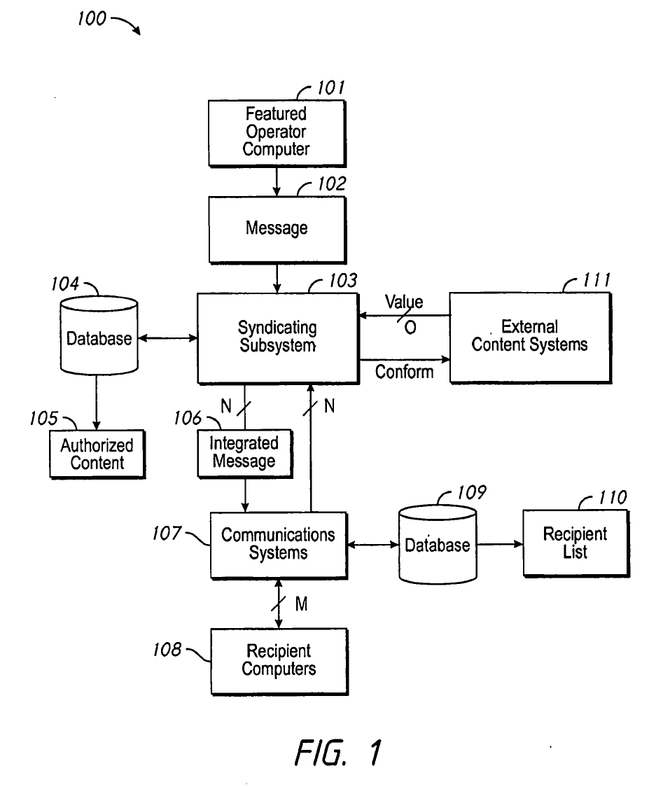

FIG. 2: An example flow chart for processing a message from a featured operator to the operator's authorized recipients.

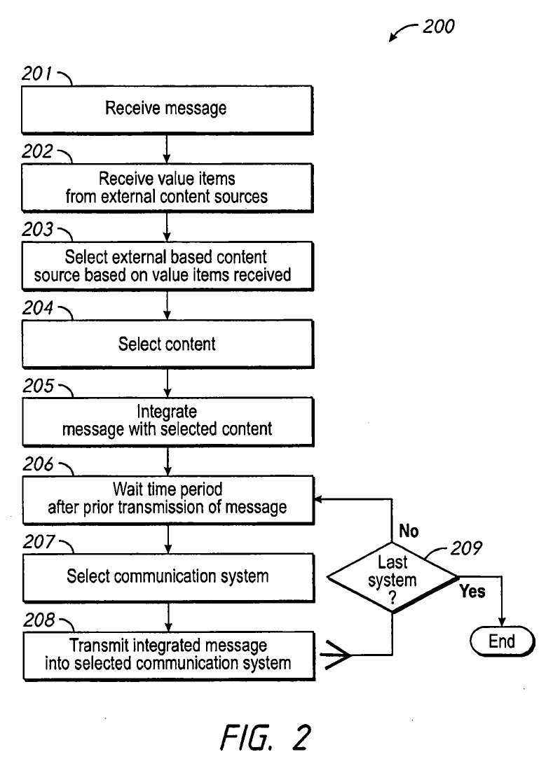

FIG. 3: An example flow chart for receipt of a message from a featured operator and activation of the message.

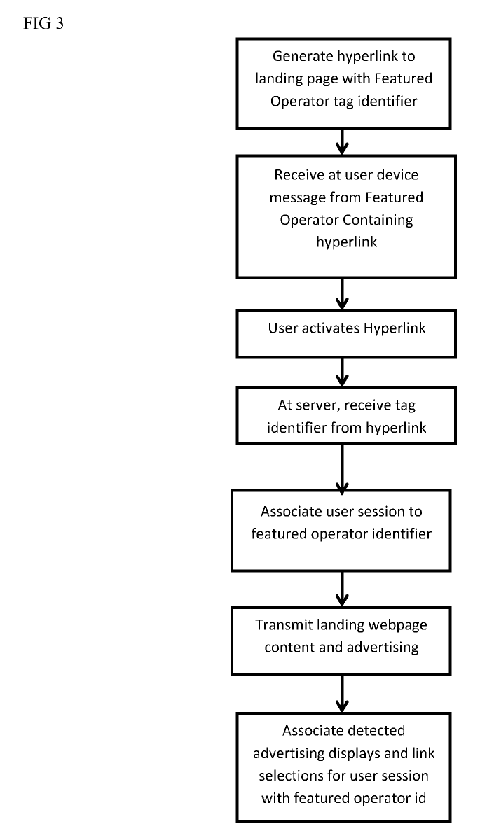

FIG. 4: A basic system diagram for implementing the invention.

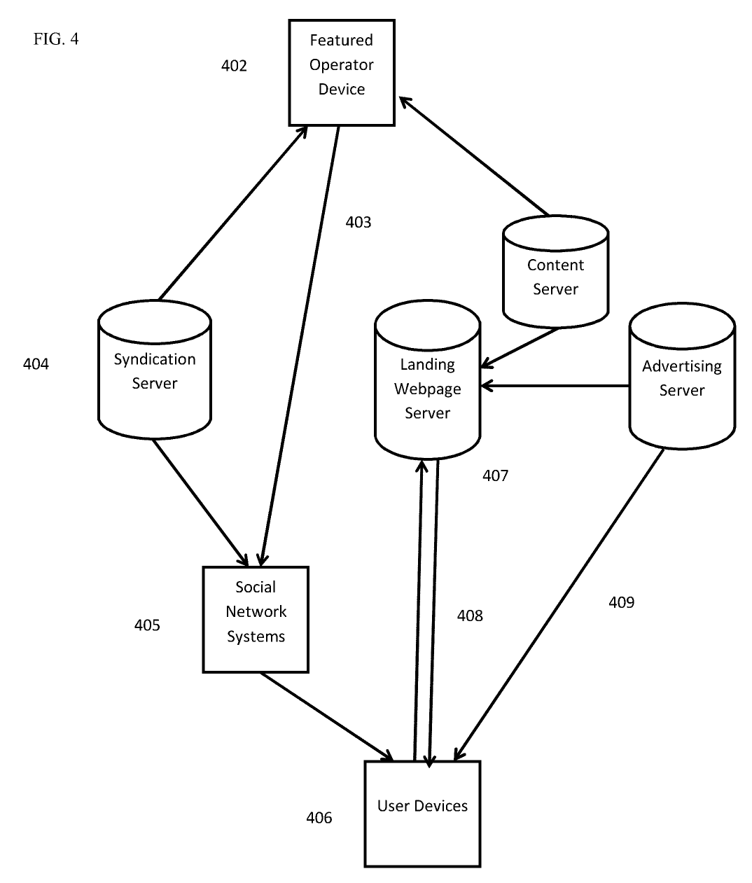

FIG. 5: A display on the operator's device that shows a heat map of where the transmitted hyperlink in the message is activated.

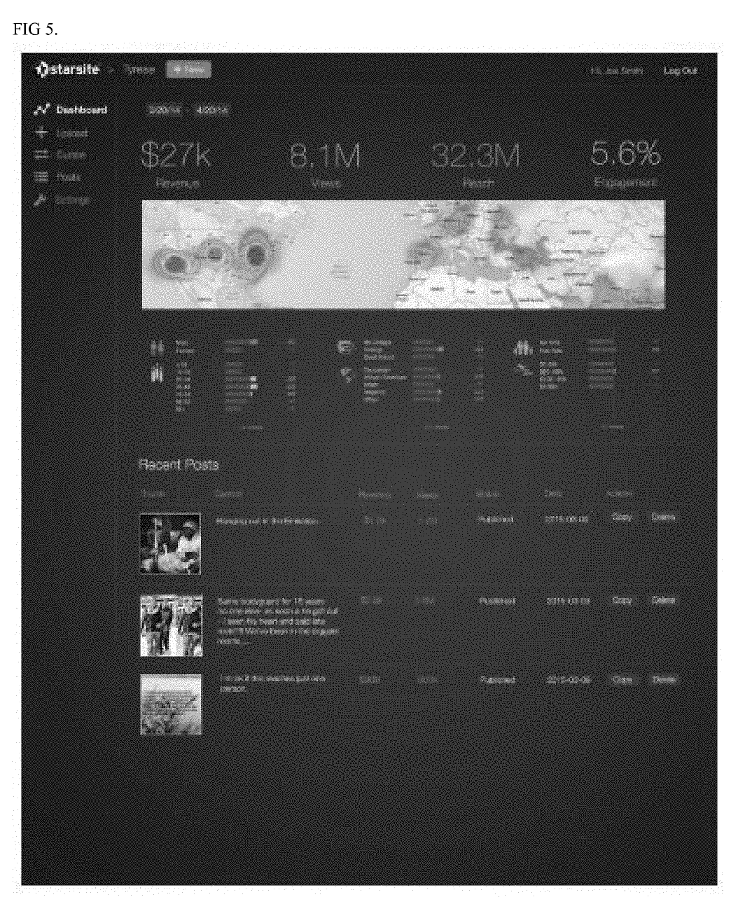

FIG. 6: A display on the operator's device that shows content that may be curated and selected for a message.

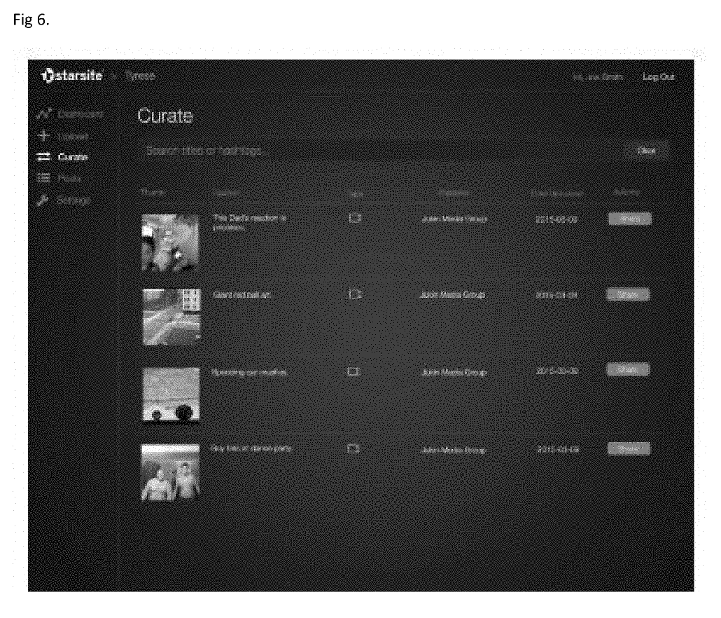

FIG. 7: A display on the operator's device that presents administrative settings for the operator.

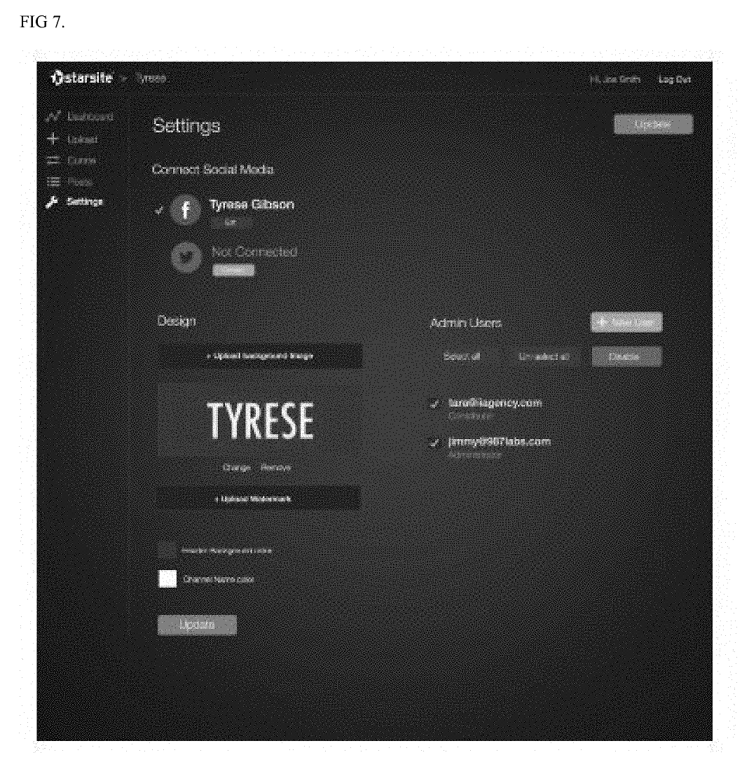

FIG. 8: A display on the operator's device that presents the operator control of capturing live video or audio as content to be used in the message feed.

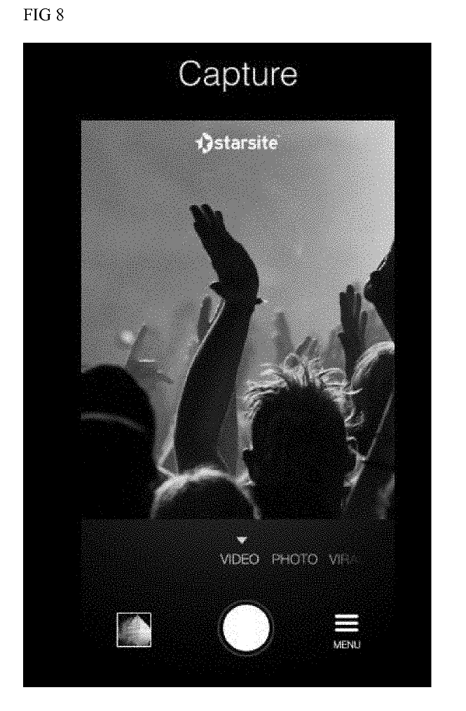

FIG. 9: A display on the operator's device that presents possible content for selection.

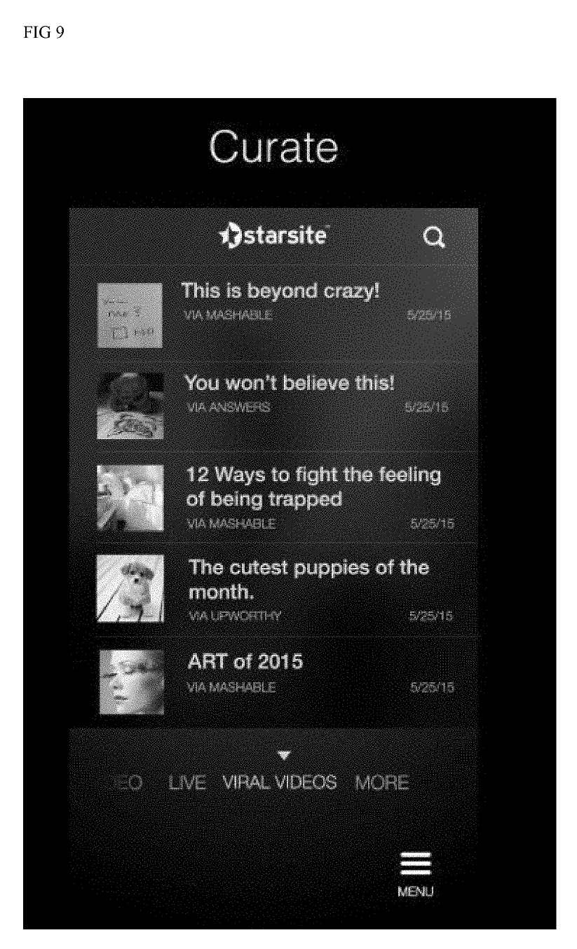

FIG. 10: A display on the operator's device that presents a selection of interactive poll questions to include in the message to users.

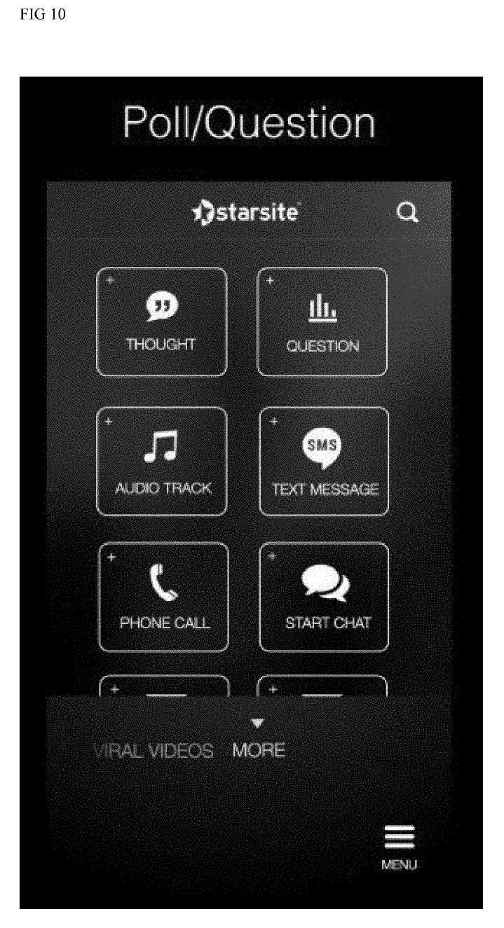

FIG. 11: A display on the operators device that presents the controls to input a message with the selected content and to select the command to share the message, as well as select social networks that are connected or not.

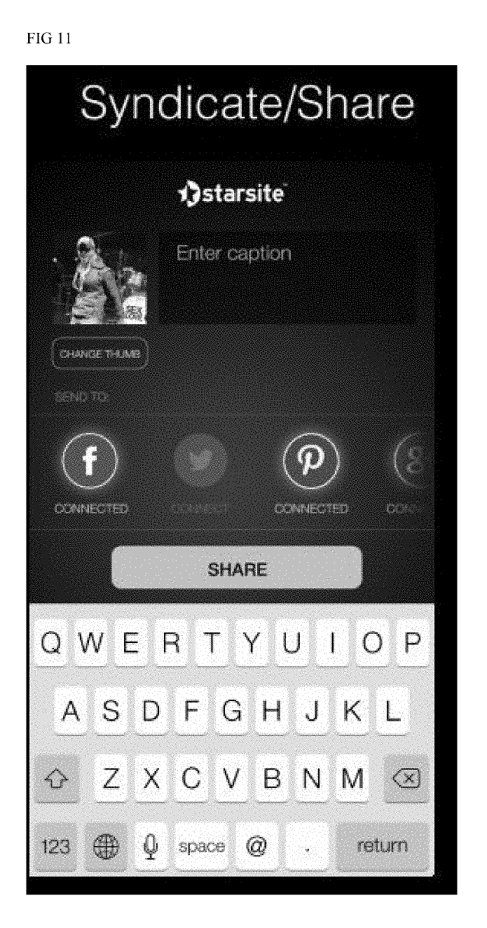

FIG. 12: A display on the operators device that presents the detected distribution and rendering of one or more message from the operator as a geographic heat-map and distribution statistics over time.

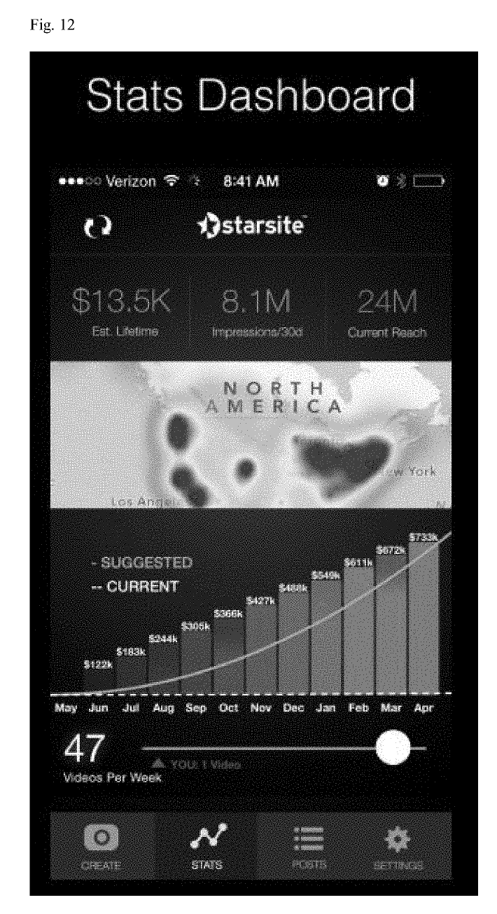

FIG. 13: A display on the operator's device that presents a list of messages transmitted by the operator.

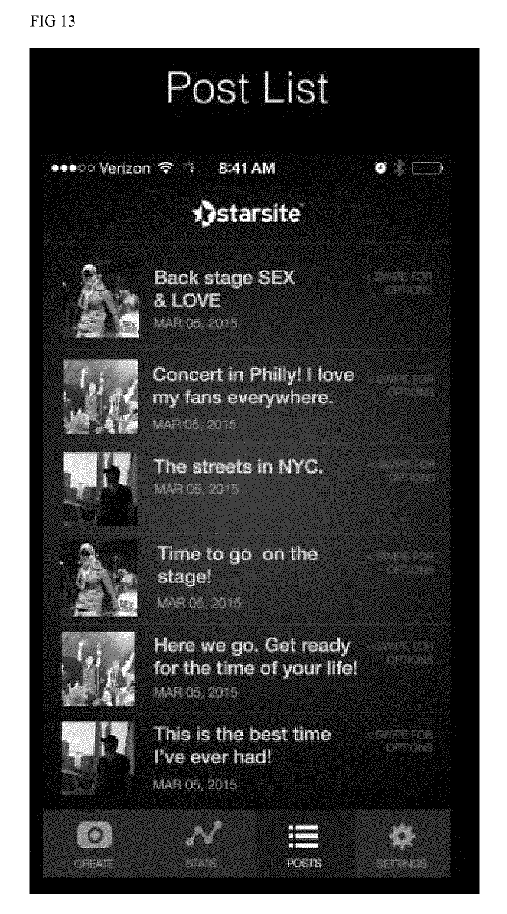

FIG. 14: A display on the operator's device that presents distribution statistics by social network for a particular uploaded message.

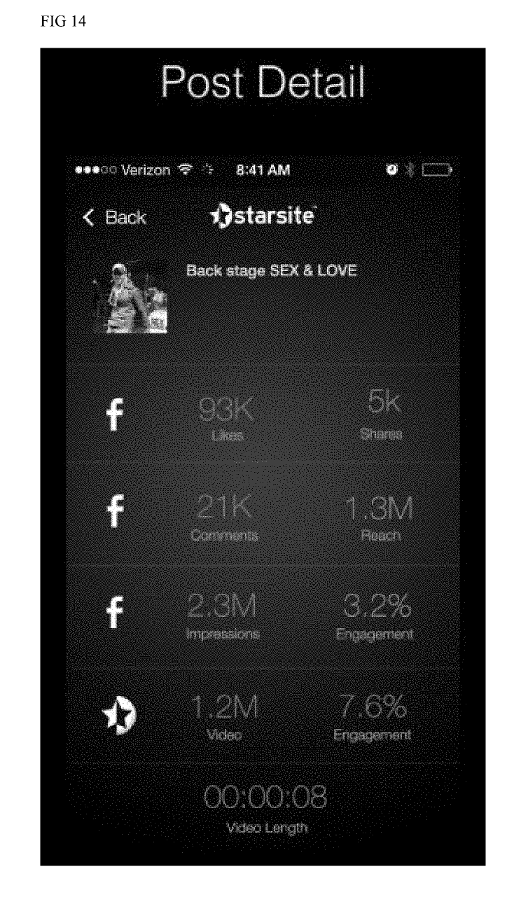

FIG. 15: A display on the operator's device that presents the status of the system and the operator's activation or deactivation of connections to social network connections.

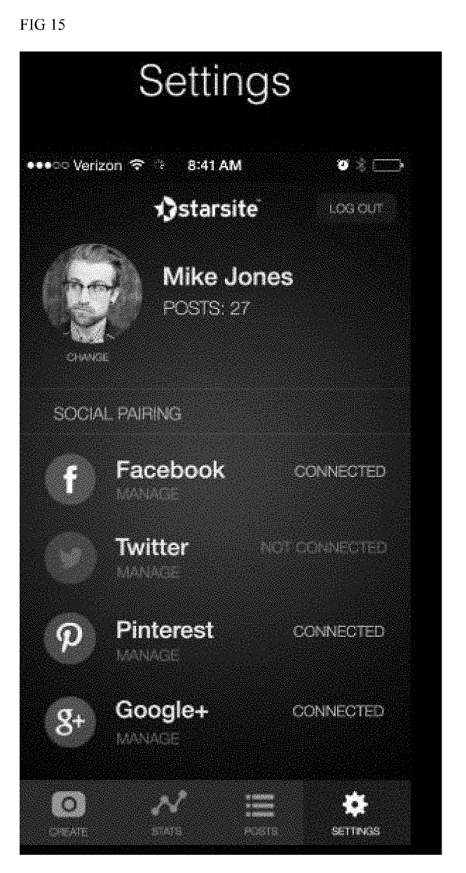

FIG. 16: A display on the operator's device that presents the operator controls to cause a message to be sent to another person in order to activate that other person as an operator.

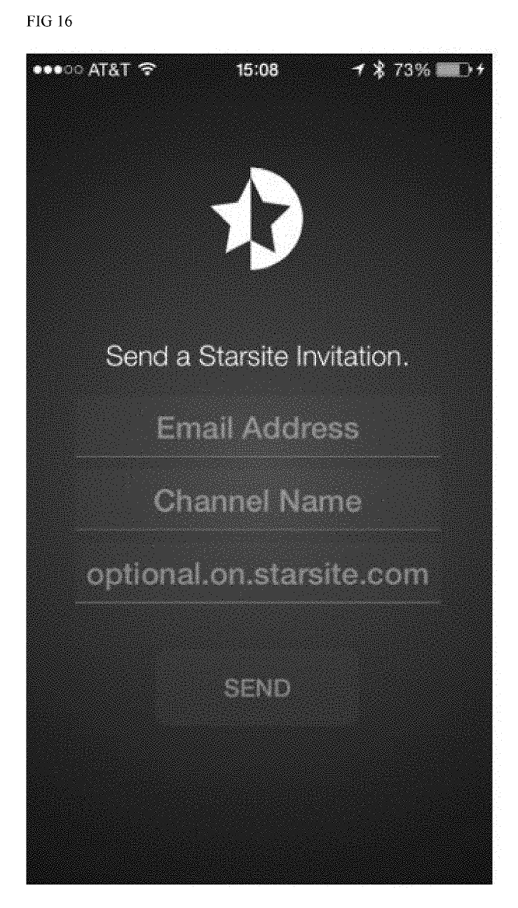

FIG. 17: A display on a person's device who received an invitation to become a featured operator of the system that presents controls to activate downloading a program onto that person's device that operates as part of the invention.

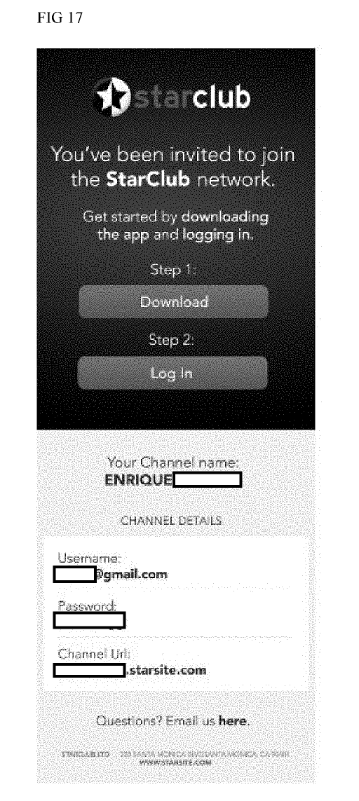

FIG. 18: An architectural diagram of one embodiment of the system for providing demographic targeted message transmission.

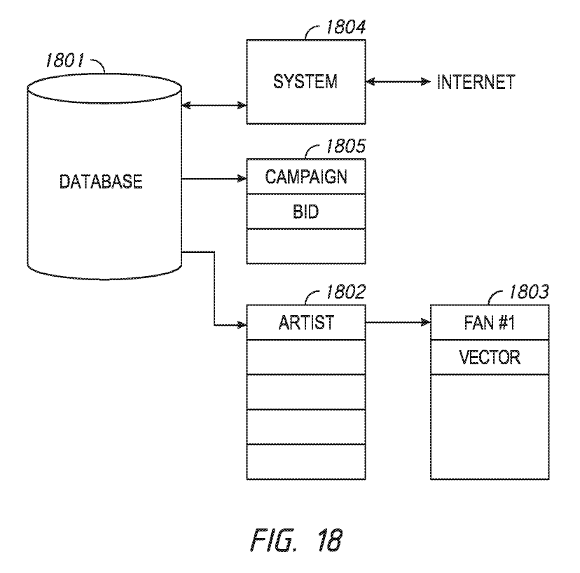

FIG. 19: A flow-chart showing process steps for demographic targeted message transmission.

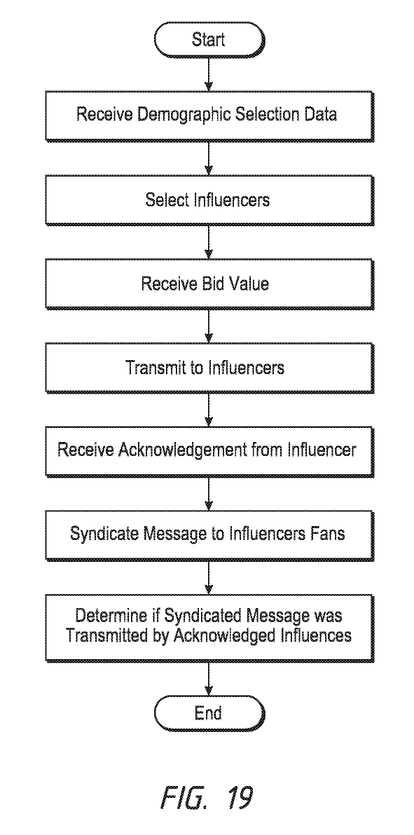

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

In the typical user to user communication network, a computer system controlled by the system owner receives data messages from one user and then re-transmits the message to the other recipient user or users on the list by means of accessing the list and then transmitting the message out to each of the recipient users. In this architecture, the communication system owner is able to control how the received messages appear to the recipient users. More importantly, the system owner is able to develop and distribute dedicated applications that operate on the remote recipient user computers that have specific protocols that operate between the remote application and the centralized computer systems controlled by the owner. This type of system places control of the appearance or selection of other ancillary content transmitted with the distributed message in the hands of the system owner.

This invention is directed toward a syndication sub-system where the communication system is operated in such a way that the featured operator can control the appearance of or the selection of content transmitted with the messages that the featured operator transmits to the featured operator's list of authorized recipients through the communications system. In this architecture, there may be more than one communication system. The overall system is then comprised of one or more communication systems. Each of the communication systems in comprised of a database that has a set of data records for each of the users. Each user in the database has a list of authorized recipients of such user's messages. In addition, each such user has a login identifier and password that permits the user to input and cause the transmission of a message to that user's list of authorized recipients.

In one embodiment of the invention, the featured operator is a user of each of the one or more communication networks (107). The featured operator operates a computer connected to the syndicating sub-system (101). That computer can generate a message that is received by the syndicating sub-system (201). In this embodiment a syndicating sub-system (103) is used by the featured operator in order to manage the transmission of messages (102) out to all of the authorized users (108) associated with all of the communication networks (107) that the featured operator is associated with. Control of the syndicating sub-system (103) is proprietary to the featured operator and is typically not shared with the owners of the communications systems (107) that the featured operator is a user of.

In this architecture, the syndicating sub-system receives a message (102) from the featured operator's computer (101). The message may be comprised of text, image, video, audio or a combination thereof. In addition, the syndicating sub-system is comprised of a database (104) that has data records (105) associated with other ancillary content, which may also be text, images, video or audio or combinations thereof. Those data records also contain references as to whether the featured operator has authorized such content to be associated with the featured operator's messages. When the featured operator inputs into the syndication sub-system a command to transmit the message, the sub-system then uses the content database (104) to call up additional content (105) from the database that has been authorized to be transmitted with the featured operator's message, as indicated by the data records in the database (104) that are associated with the featured operator. The syndicating sub-system automatically modifies (205) the data comprising featured operator's message in order that the message has the content integrated into it. (106)

In one embodiment, the featured operator's message is an audio-visual message containing a performance (201). The syndicating sub-system may then take the data file comprising the audio-visual message and select and retrieve another audio-visual data file from the content database (204), and combine the two into one audio-visual data file output (205) or a message containing links to both, or a message containing the performance audio-visual data with a link to the second selected audio-visual file content. In one embodiment, the content is an audio-visual data file and the data in that file is placed into the audio-visual data file comprising the featured operator's message. This output is then transmitted into one or more communications systems that the featured operator may use. In this way, the recipient users that receives the message from the featured operator will first see the selected content before the performance is rendered on their device. As noted above, in another embodiment, the audio-visual files may be delivered first by one or more links in the data message to the recipient user that are then activated by the recipient users' device, so that the device fetches the audio-visual data from a location referenced by the link.

In another embodiment, the data file comprising the integrated message (106) transmitted to the communication networks is a hyperlink. When that hyperlink is transmitted to the authorized recipients' computers (108), the hyperlink (either by being actuated by the recipient, or automatically actuated by the recipient's computer) causes an iframe to be presented on the recipient's computer (108) that is fetched from the syndicating sub-system's servers (103). At that point, the sub-system determines which featured operator the request is associated with because the transmitted hyperlink may have a unique alpha-numeric string embedded in it that identifies it uniquely with the featured operator. Using that determination, the sub-system then selects content (204) and transmits the content directly to the recipient's computer for display in the iframe, along with the featured operator's message. In this embodiment, the request received from the authorized recipient can include additional data about the recipient, for example, which recipient in the list that recipient is. In addition, the sub-system may deposit a small data file on that recipient's computer or access other data files that indicate how that user has used the Internet. This data can be used by the sub-system or other systems that track usage of the ancillary content to further select content or calculate a value associated with the transmission of the content, as further described below.

In yet another embodiment, the first frame of the audio-visual message is comprised of a gif formatted image file that contains a hyperlink. In another embodiment, the hyperlink opens a channel with the syndicating sub-system in order that the rest of the audio-visual message is streamed to the recipient's computer device. In embodiments using mobile devices, there may be an app running on the device that operates as a dedicated browser. This browser may receive a data message that is comprised of a link to the sub-system servers that then calls up the featured operator's message (102) and the selected content (105).

The demographic data can also be extracted by inspecting the IP address of the incoming HTTP request associated with activating the hyperlink. Another embodiment uses the hyperlink to take the recipient computer to a web-page associated with the sub-system and the web-page can save an identifying data file on the recipient's computer that can be used to track usage. In yet another embodiment, an authorized recipient may have a user account with the sub-system so that they may directly transmit responding messages to the featured operator. In this system, the recipient has to input demographic or other data into the sub-system that is then stored in a data record associated with the recipient user. Using this feature, the system can use the identifying data retrieved from the recipient computer to associate the activated hyperlink with a particular user and their data stored on the sub-system. By aggregating all of the recipient data associated with a particular transmitted message or more broadly, with the featured operator, more particular information about the characteristics of the recipients who may interact with the message may be determined by the sub-system in a manner independent of which communication system the recipient used to receive the featured operator's message.

In yet another embodiment, the syndication sub-system (103) accesses the account of the featured operator on each communication systems (107) in order to retrieve any communication traffic by and among the recipients where the featured operator is included as a recipient of such traffic. This data may comprise responding text message or other content. This data may be inspected in order to extract information by means of using key words in combination with IP addresses in order to create a data record that associates a recipient with a particular identifier with a set of key words. In a version of this approach, the key words may be a set of predetermined words or synonyms and the data record a string of frequency values that are the frequency with which the particular recipient user has used such words. The string of frequency values may be stored in a data record associated with the user and the featured operator.

The syndication sub-system then accesses a database (104) that contains data records associated with one or more featured operators. That database may include data records that list communications systems (107) that the featured operator is a user of, and the login and passwords associated with those user accounts. At that point, the syndicating sub-system (103) automatically logs into the one or more communications systems (107) using the featured operator's login credentials and inputs the final formatted and integrated message (106) into the communication system.

The syndication subsystem can also operate a process that checks each communication system for the number of recipients in the authorized recipient list, and in one embodiment, a verification of the number of the recipients who viewed the transmitted message. Upon receiving this data from each communication network, the syndication sub-system then stores in its database, in data records associated with the featured operator, the number of recipients of the message along with the identity of the selected content that was transmitted with the message.

Periodically, the syndicating sub-system can use the stored data indicating the number of recipients of the selected content to then calculate a value associated with the transmission of the selected content. The calculated result may be received by the featured operator computer or the syndicating sub-system (202).

In yet another embodiment, the syndicating sub-system does not send the featured operator's message out to all of the communication systems at once. Instead, the sub-system sends the message out to the communication systems (207) seriatum. The sub-system may use a predetermined period of time between sending the message out on one communication system before submitting the message out to the next communication system (206). In this way, the syndicating sub-system can spread out over a longer period of time the transmission activity of the same message sent by the featured operator. By spreading out the transmission activity (208), the interaction activity of the authorized receiving users across all of the communication systems is also spread out in time. In this embodiment, the spread-out activity data alleviates the lag time between the authorized recipient's interaction activity with the featured operator's message and the detection by the external content systems of the interaction activity. If the content integrated into the message includes a hyperlink that can be activated by an authorized recipient user on one of the communication systems, then in total, the activating activity of all of the authorized recipients of the featured operator across all of the communications systems are then spread out over time. The activation may occur by the user operating their device in order to select the hyperlink by operating the graphical user interface of the device. This spreading effect of the recipient user activity with the selected content may be detected by other computer systems that receive data associated with the user's activity, for example, viewing rates or click-through rates.

The user activity data can then be used as input into a calculation of a value associated with the transmission of the selected content integrated with the featured operator's message that is assigned by the other computer systems that receive the user's activity data. This value item may be a number received by the syndication sub-system so that the selection of content can be made in dependence (203) on such value items received from the one or more external content systems (202). Once the sub-system selects an external content source based on that source's determined value (203), the sub-system will use as the selected content that content that is further determined by such external content source (204). This can be by receiving selected content from the external content system, or receiving a reference to such content that is already stored on the sub-system's data base. (104).

In yet another embodiment, another content selection sub-system receives data from one or more other external content systems (111) representing from each the value each system associates with the transmission of the featured operator's message (202). In this embodiment, each of the external content systems use the detected interaction activity data to determine its own value that is submitted to the syndication sub-system. The content selection sub-system can then use the received values from the one or more external content systems to select the content for integration into the message (106) for submission to the next communication network (107). In one embodiment, the selection of which order of the several communication networks to be used to transmit the message may be determined by the syndication sub-system in a manner that results in the sub-system receiving a highest (or lowest) value item for the transmission of the message, and selecting content associated with the external content system associated with such highest or lowest value item.

Once the communication systems have received the integrated message (107) and a command to transmit it, the systems then retrieve from a database (109) the list of authorized recipients (110) associated with the featured operator, or the operator's computer (101). The communication systems (107) then uses the retrieved list to send the integrated message (107) to the authorized recipient computers (108).

In other embodiments, there may be a curate feature in which a content-selection system (403) syndicates content (videos, pictures, etc.) from external (“third-party”) sources (401), including aggregator sites, and provides selected items to the featured operator (401) for review on the operator's app (402). Through this feature, the featured operator can review a variety of content relevant to their social media communication goals and interests, and can personalize it across platforms from one central application. The system selects content specific to the featured operator's brand and interests though a unique tagging system that permits the featured operator to easily curate their feed. This enables the operator to review thematically filtered content in a time and labor efficient manner. In one embodiment, the featured operator is associated with a set of tags or keywords. These are stored in a database record associated with the featured operator. The featured operator can input those keywords into the system using a user interface on their app operating on a device. The system receives content from other sources and the content is also associated with tags or keywords. When the system receives content, the system operators can input those keywords into the system through a user interface as well. A database record associated with each piece of content can contain one or more tags or keywords. The system determines whether the content or a link to the content is further distributed to operator's apps, and if one of the tags associated with the content matches one of the tags associated with the featured operator. Alternatively, more complex logic may be used that matches more than one keyword, or prioritizes one keyword over another. In any case, the featured operator sees candidate content for review that has been pre-filtered based on the keyword preferences. The system retrieves the matching content from the database and transmits the content to the featured operator's device. In one embodiment, the system will create a thumbnail image or an initial image of an audiovisual file and transmit that to the featured operator's device. That image can be an active ink that when viewed by the featured operator, can be selected by the featured operator by touching the screen of the device so as to indicate a selection of that audiovisual file.

The automatic sorting of this content, and the matching of it to a user, relies on a list of preferences which are submitted by the featured operator to the system, and tagged as keywords. The system will independently tag all syndicated content according to preset content labels. On their app user interface, every featured operator will be able to select their categories of interest. The system stores these as content tags.

When filtering syndicated content, the system will then match the material's assigned values to the ones selected by the featured operator. It will present—daily, in some cases, continually in others—the filtered content to the operator as a list of links, complete with all associated keywords. The featured operator can review this content on the interface of their instance of the app, and can choose to upload that content to all of their followers on social media networks by clicking a “share” or “upload” button on the user interface of the application running on the featured operators device. (402) In one embodiment, the featured operator can input into the app a message as text to accompany the uploaded content. Both the message and the content is then redistributed through the featured operator's social networks. By upload or distribution, it is understood that this may be accomplished by transmitting the content data itself or a link to the content. The syndication server (404) creates a message for distribution that includes a hyperlink to a landing page hosted on the webpage server (407) where the selected content will be located. The upload may be through the syndication server (404) to a set of social network systems (405) or directly (403) from the operator's device to the social network systems (405). Thus the system allows artists or other celebrities who are the featured operators, to personalize third-party content and incorporate captions before uploading it. This additional function is to enable consistent engagement and enhance media presence for all of the featured operators through efficient content filtering and convenient sharing options.

The social networks transmit the operator's message to the featured operator's list of recipients (406). The hyperlink to the landing page is embedded in the message. When the hyperlink is activated on the recipient user's device (406), requests are made from the recipient user's device to the landing webpage server (407). The landing webpage server then transmits back the content plus any advertising that is integrated with the content (408). In addition, the landing webpage can also generate requests directly from the advertising server (409).

There is a sub-system dedicated to allocation of a feature operator's advertising revenue share, and to facilitating payment. This consists of a tracking method which calculates the share of advertising revenue that belongs to that a given operator. A reporting feature includes an interactive display on the operator's app. This particular page, referred to as a “dashboard”, displays analytical data related to the distribution of content to the operator's social network. In one embodiment, the dashboard presents viewing activity of the content, which can be displayed as a heat-map on a map of the world. In another embodiment, the system tracks advertising revenue in real time, showing how much advertising revenue associated with the operator has been generated by a particular upload or during a selected period of time. The revenue feature calculates and displays an operator's share by metrics which show the user's share per each specific user upload and the total share earned by a user on the system per week or other time period. For example, if a user uploads a video content for distribution to their social network, that video will be accompanied with advertising that may be charged on a per-view basis. The system tracks the number of views, including the identity of the recipient, in order to determine that the user uploaded the content being viewed. As a result, the system can calculate the number of views of a specific piece of advertising attributable to a specific user. In addition, the system determines the IP address of each recipient of the content, and by mapping the IP address to a geographic location, can then use that geographic data to populate a heat-map data output that can be displayed on the dashboard. Based on the advertising rate, an amount may be charged to the advertiser, and a predetermined share of such revenue associated with the user may be calculated.

The payment system offers “cash out” option on the operator's dashboard. This is integrated with a payment application. Operators may choose whether to have their share of revenues deposited in a bank account or transferred to their PayPal account. Once this feature is set-up, payment occurs when the user requests it. When a user selects the “cash out” option, a command is transmitted to the system server. The command is verified, and then the system relies on pre-stored payment instructions associated with the operator, for example, bank wiring or ACH instructions, to transmit the amount of money earned by the operator by means of the advertising system. The payment sub-system transfers funds to the designated account, and then resets the database of what the operator is owed to reflect the new balance after payment. The dashboard is updated accordingly.

The operator's dashboard includes several displays of the system's data analytics. These include a link to a page displaying content viewership information gathered from the recipient user data that the system has collected, analyzed and categorized. Such information contains a map showing viewership geographically compiled by IP address mapping, the number of potential viewers reached across all social network platforms, and the number of times content has been viewed. Landing page data and all other application statistics are displayed with updates in real time, including vertical social media data with important demographic trends from viewer's country to socioeconomic categories. All of an operator's posts and uploads are displayed along with their status (eg. “published”), number of views, revenue, and various options such as “delete” or “copy.”

The system ensures that all of an operator's content is uploaded to all social networks where the operator has a branded landing page. A “settings” tab on the dashboard, when clicked, offer options that control to which social networks and other web platforms the system will upload content, the features of the branded page, and the persons authorized to upload content on the featured operator's behalf. The operator may select which communication network system the upload or share command should apply to.

In another embodiment is a method for integrating advertising with shared content in a way increasing the likelihood of a viewer's interaction with advertising. The system places sponsored content directly on the operator's branded landing page as part of the artist's posting. The advertising plays immediately along with the operators's uploaded content. That is, there is no pre-roll advertising prior to video plays: both forms of content run simultaneously. Viewers cannot click-through to bypass the advertising, since both forms of content are fully integrated with each other. In another embodiment, the integration takes place on the webpage server by taking the selected content, combining it with the selected advertising content, and then creating one data stream that contains both pieces of content in the single feed of audio visual data transmitted to the user's device for rendering. All of the advertising is interactive and can be engaged with by viewers through links on the landing page; such interaction is monitored by the system and displayed on the user's dashboard metrics. Clicking on the displayed advertising can launch a browser at the advertiser's predetermined webpage.

Conflicts of endorsements can be a significant concern for talent: a content provider could run an advertisement from a sponsor who is in competition with an artist's exclusive endorsement, alongside content posted by that artist. The system employs a unique method to prevent these conflicts. An automatic filter maintains up-to-date operator restrictions, detailing which advertisements can or cannot be incorporated into each use's uploaded content. A database record associated with each operator contains a list of the operator's exclusive deals, contracts, and endorsement is stored in the system and tagged, which are referred to as restriction tags. Similarly, all advertisements receive labels identifying their sponsors. Prior to running any advertising on an operator's landing page, content, the system checks the sponsored content labels associated with the operator against the user's restriction tags to prevent a conflict of interest or a potential violation of an exclusive agreement. Only content vetted by this process will appear as part of the integrated messages uploaded to any user's branded landing pages. In another embodiment, the system stores in the operator's data record a list of prohibited brands along with the list of operator associated brands. The system logic then only permits an advertisement to be loaded on the operator's landing page that is not associated with the user's prohibited brand list. In yet another embodiment, the system has data records associated with all of its advertiser's brands that lists a plurality of that advertiser's competitor's brands. In this embodiment, the system logic also checks that the advertising brand tag does not conflict with the competitor list of the operator's endorsement brand list.

In yet another embodiment, the system also permits an authorized user review incoming content to affirmatively select which featured operator can view the content in order to decide to share it.

The featured operator can upload third party content that the operator curates, or images taken by their portable device operating the app, or initiate a live stream of audio and or audio and video through the app and out to their viewers by means of distribution of a link through their social network.

In order to track use of the content and any advertising, the system assigns a unique token to each upload from the feature operator that is also unique to each of the social network communication systems the featured operator selects. This token may carried along with the content in the URL of the link that is transmitted or otherwise embedded in the transmitted content.

There may be more than one token transmitted: one token may be for identifying the content and the other for identifying the artist. In this way, the transmitted URL that is launched on a viewer's browser causes the token to be sent back to the system's ad-serving computers, and by that means, the artist is identified as is the content. Similarly, any advertising transmitted to the artist landing page includes the artist token, so that when selected by the viewing user, the artist token is returned back to the ad serving computer. In this way, the viewing is associated with the artist and can be tracked.

When an artist selects content for sharing using the curation function, the artist can also input a time schedule selection to schedule when the sharing of the content will occur.

A featured operator, which can be an artist, is invited to the system by receiving an authorized email with a link. Operating the link brings the artist to a user agreement. If the artist agrees, then the artist is brought to a page to input the authentication data necessary for the system to interface with the various social network communication systems the artist uses. In addition, the system initiates the artist account by creating a data record in its database associated with the artist. Further, the system creates a URL for the artist's landing page on the content server, a channel name, a URL on the ad-server. In addition, the system creates a unique version of the app that the operator uses to interface with the system. The app is modified to be unique to the artist for enhanced security. There is one app, but it has internal credentials that are customized for each artist. In addition, the content management generates a unique token to be associated with the artist.

### Demographic Targeted Message Transmission

In yet another embodiment of the invention, the system can be adapted to provide a mechanism for demographic targeted message transmission. In this embodiment, a party, typically a brand inputs into the system data representing characteristics that the brand would like to target for a promotional message. Example demographic characteristics can include geographic location, age, gender, ethnicity, nationality, income and net worth. The characteristic can include genres of music, film, art or other popular entertainment. The series of demographic values created by this input is referred to as a demographic vector.

The system contains a database (1801) of all featured operators, typically celebrities. Each operator has a data record (1802). The featured operator data record refers to at least one authorized recipient associated with that operator (1803). That recipient's data record is comprised of a demographic vector for that recipient. (1803). A relational database is a preferred embodiment because it permits one data record for a recipient to be associated with more than one featured operator—which would typically be the case. The received demographic vector data is used to select all of the authorized recipient data records in the database whose individual demographic vectors sufficiently match the input demographic vector based on a predetermined criteria. The criteria can include a percentage departure from the requirement, an input that is specified as an acceptable range, e.g. between the ages of 18 and 21 or if a sufficient number of the vector components match. Criteria can be further specified where a subset of vector elements are required to be a match while others are not exclusive. For example, a selection test may require that the vector indicate a female gender, be within an age range of 18-24, and then fit any one of ten different geographic locations. The selection test options can be presented on a screen to the personnel operating the system so that the system can customize the selection test criteria. Then, using database manipulation techniques, the authorized recipients can be selected. Further, all of the featured operators who are associated with the selected authorized recipients can be determined. A list of the determined featured operators is created, where the featured operators may be ranked. One example ranking is the fraction of the selected authorized recipients that are associated with the featured operator. Some featured operators may have only a few associations with authorized recipients that sufficiently match the input demographic vector while others are dominant. A pre-determined test, which can be a minimum fraction value, or a minimum ranking level can be used to cull the determined featured operators to a finally determined useful and sufficiently practical list of featured operators.

The system can then transmit a bidding message to each of these finally determined featured operators on behalf of the brand that is performing the promotion. The bidding message may be comprised of information about the product or service being promoted and data representing an amount the brand is willing to pay the featured operator to promote the product or service. The featured operator that receives the bid message may respond to it by submitting an acknowledgement data message to the system.

When the system receives the acknowledgement, a content message is generated that is submitted to the syndication system described above in order that the message get transmitted to the acknowledging featured operator's authorized recipients. In addition, the system has an authorized recipient account with each featured operator, so the transmitted message can be confirmed to have been sent through the acknowledging featured operator's network in the syndication data flow. Upon confirmation, electronic payment processes can be initiated to credit the system with payment and to transmit payment to the featured operator.

In another embodiment, the database may not have data records for each specific authorized recipient of a featured operator. Instead, the database may have a cumulative demographic data vector associated with each featured operator, where the system calculates or otherwise obtains that vector data as an aggregated number. In this embodiment, the system operates a communications platform that receives one or more HTTP requests from one or more computers in response to communications that might present information about the featured operator. These HTTP requests will contain IP address information that can be mapped to determine approximate geographic location. In addition, the platform may utilize small data files deposited on the one or more computers that provide tracking data that can be further utilized to determine additional demographic data. In yet another embodiment, the message syndication system transmits messages that invite authorized recipients to respond to the featured operator, thereby generating HTTP traffic to the system. Over time, the system will be able to use this HTTP traffic to build out a demographic data vector for the featured operator. This cumulative demographic data vector that is associated with each featured operator that represents the demographic characteristics of the audience of the featured operator. The system can then determine featured operators by determining a sufficient match between the cumulative demographic vector data associated with the featured operators with the demographic data vector submitted by the brand, using the selection criteria.

### Operating Environment

The system and method described herein can be executed using a computer system, generally comprised of a central processing unit (CPU) that is operatively connected to a memory device, data input and output circuitry (I/O) and computer data network communication circuitry. A video display device may be operatively connected through the I/O circuitry to the CPU. Components that are operatively connected to the CPU using the I/O circuitry include microphones, for digitally recording sound, and video camera, for digitally recording images or video. Audio and video may be recorded simultaneously as an audio visual recording. The I/O circuitry can also be operatively connected to an audio loudspeaker in order to render digital audio data into audible sound. Audio and video may be rendered through the loudspeaker and display device separately or in combination. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

The remote computer may be a laptop or desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The system may also be comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps.

In one embodiment, a user's computer can run an application that causes the user's computer to transmit a stream of one or more data packets across a data network to a second computer, referred to here as a server. The server, in turn, may be connected to one or more mass data storage devices where the database is stored. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be one or more data packets transmitted from or received by a computer containing a destination network address, a destination process or application identifier, and data values that can be parsed at the destination computer located at the destination network address by the destination process in order that the relevant data values are extracted and used by the destination process.

The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

In addition, the user's computer may obtain data from the server that is considered a website, that is, a collection of data files that when retrieved by the user's computer and rendered by a program running on the user's computer, displays on the display screen of the user's computer text, images, video and in some cases outputs audio.

The access of the website can be by means of a client program running on a local computer that is connected over a computer network accessing a secure or public page on the server using an Internet browser or by means of running a dedicated application that interacts with the server, sometimes referred to as an “app.” The data messages may comprise a data file that may be an HTML document (or other hypertext formatted document file), commands sent between the remote computer and the server and a web-browser program or app running on the remote computer that interacts with the data received from the server. The command can be a hyper-link that causes the browser to request a new HTML document from another remote data network address location. The HTML can also have references that result in other code modules being called up and executed, for example, Flash, scripts or other code. The HTML file may also have code embedded in the file that is executed by the client program as an interpreter, in one embodiment, Javascript. As a result a data message can be a data packet transmitted from or received by a computer containing a destination network address, a destination process or application identifier, and data values or program code that can be parsed at the destination computer located at the destination network address by the destination application in order that the relevant data values or program code are extracted and used by the destination application.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Javascript, C, C++, JAVA, or HTML or scripting languages that are executed by Internet web-browsers) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

It is appreciated that any of the software components of the present invention may, if desired, be implemented in ROM (read-only memory) form. The software components may, generally, be implemented in hardware, if desired, using conventional techniques. In some instances, especially where a mobile computing device is used to access web content through the network (e.g., when a 3G or an LTE service of a mobile phone is used to connect to the network), the network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), or Voice over Internet Protocol (VoIP), Unlicensed Mobile Access (UMA).

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Also, while processes or blocks are at times shown as being performed in series, these processes or blocks may instead be performed or implemented in parallel, or may be performed at different times.

What is claimed:

1. A computer system adapted to transmit a message and a selected content to an authorized recipient comprising:
a selection sub-system that is adapted to receive at least one data representing at least one corresponding demographic data, and using the received demographic data, select at least one featured operator by selecting at least one authorized recipient data records comprised of demographic data that sufficiently matches the received demographic data and determining the at least one featured operators that are associated with data records that are comprised of data indicating an association with at least a pre-determined fraction of the selected authorized recipients;
a bidding subsystem that is adapted to receive a proposed bid amount, to transmit the bid as a data message to the selected featured operators, and to receive an acknowledgement data message from the at least one featured operating confirming acceptance of the bid;
a syndicating sub-system that is adapted to receive a content data message and transmit the content data message to a one or more communication systems, where said one or more communication systems are connected to the syndicating sub-system by means of a data network, said one or more communication systems adapted to receive from the sub-system the integrated message, where the one or more communication systems are further adapted to:
retrieve from a database a plurality of logical addresses for authorized recipients associated with the identity of the acknowledged featured operator;
and transmit the received integrated message to the retrieved authorized recipients.

2. A computer system adapted to transmit a message and a selected content to an authorized recipient comprising:
a selection sub-system that is adapted to receive at least one data representing at least one corresponding demographic data, and using the received demographic data, select at least one featured operator data record, said data record comprised of a demographic data vector by determining the demographic data vectors in the database that sufficiently match the received demographic data;
a bidding subsystem that is adapted to receive a proposed bid amount, to transmit the bid as a data message to the selected featured operators, and to receive an acknowledgement data message from the at least one featured operating confirming acceptance of the bid;
a syndicating sub-system that is adapted to receive a content data message and transmit the content data message to a one or more communication systems, where said one or more communication systems are connected to the syndicating sub-system by means of a data network, said one or more communication systems adapted to receive from the sub-system the integrated message, where the one or more communication systems are further adapted to:
retrieve from a database a plurality of logical addresses for authorized recipients associated with the identity of the acknowledged featured operator;
and transmit the received integrated message to the retrieved authorized recipients.
